(19) United States
(12) Patent Application Publication
(10) Pub. No.: US 2007/0214440 A1
(43) Pub. Date: Sep. 13, 2007

(54) Method for indicating differential signal lines in a layout

(76) Inventors: Yu-Chuan Chang, Taipei (TW); Yi-Hsin Hsieh, Taipei (TW)

Correspondence Address: RABIN & Berdo, PC, 1101 14TH STREET, NW, SUITE 500, WASHINGTON, DC, 20005, US

(21) Appl. No.: 11/369,836

(22) Filed: Mar. 8, 2006

(51) Int. Cl. G06F 17/50

(52) U.S. Cl. 716/5

(57) ABSTRACT

A method for indicating differential signal lines in a layout is provided, which comprises searching line groups having similar line names at first; dividing the line groups into a first line and a second line; confirming that the first and second lines are connected to a same circuit element; highlighting the first and second lines, thereby eliminating the trouble in searching differential signal lines.

### BACKGROUND OF THE INVENTION

1. Field of Invention

The present invention relates to a layout method, and more particularly to a method for indicating differential signal lines in a layout.

2. Related Art

Due to the advantages of high speed, low voltage-swing, low power, and high noise tolerance, differential lines have gradually become the trend of the circuit design. Therefore, the circuit design of an electronic product usually contains multiple groups of differential signal lines. According to the current layout method, a layout operator should find out each group of differential signal lines with reference to a list and adjust the wiring. As such, the method is time consuming, and some lines may be neglected. Moreover, the differential signal lines must be disposed symmetrically during arrangement; therefore, a wire adjustment needs to be performed previously to avoid the situation that the layout operator needs to adjust the wiring again since there is no extra wiring space in the circuit board, which is extremely inefficient.

Referring to ROC patent publication No. 540273, a method for indicating the state of trace applied in a layout is disclosed, in which a trace selection is made to input a limited range of length, and based on a path a cursor passes, a length of the path is obtained. After comparing the two lengths, when the obtained length of the layout does not fall in the limited range of length, the traces are highlighted.

The above method can allow the layout operator to quickly find the traces of a length falling in the limited range of length, and thereby overcome the problem of computation error made by the operator, but it cannot be used to perform searching and indicating for the differential signal lines.

Referring to ROC patent publication No. I228021, a method for arranging assistant differential signal lines is disclosed, in which a group of differential lines are specified previously, then according to the initial coordinate specified by the user, a corresponding dual coordinate is found out. The layout is deployed from the initial coordinate, meanwhile, the lines corresponding to the dual coordinate are generated. Therefore, the circuit layout of differential signal lines is completed.

The above method is directed to the connection of differential signal lines; however, a group of differential lines should be specified previously to perform the related wiring operation, which still has defects of inconvenient operation.

Therefore, it becomes a problem to be solved by researchers how to provide a method for indicating differential signal lines in a layout to eliminate the trouble in searching the differential signal lines.

### SUMMARY OF THE INVENTION

In view of the above problems, a main object of the present invention is to provide a method for indicating differential signal lines in a layout, which includes searching lines having similar line names automatically through a program, and determining whether the line is a differential signal line or not. The lines are highlighted when they meet the determination condition, for the layout operator to make a quick selection, thereby to eliminate the trouble in searching the differential signal lines.

Therefore, in order to achieve the above object, the method for indicating differential signal lines in a layout disclosed in the present invention relates to indicate the corresponding differential signal lines in a line diagram of preplaced circuit elements. The method comprises searching line groups having similar line names at first, wherein “similar line names” refers to names different in one letter or one symbol only; dividing the line groups into a first line and a second line; confirming that the first line and the second line are connected to the same circuit element; and highlighting the first line and the second line, for example, by changing the indication color, glittering the wiring, or thickening the wiring.

Moreover, in order to achieve the above object, the method for indicating differential signal lines in a layout disclosed in the present invention relates to indicate the corresponding differential signal lines in a line diagram of preplaced circuit elements. The method comprises selecting a line start element and a line end element connected with each other at first; searching line groups having similar line names between line start elements and line end elements, wherein “similar line names” refers to names different in one letter or one symbol only; dividing the line groups into a first line and a second line; and highlighting the first line and the second line, for example, by changing the indication color, glittering the wiring, or thickening the wiring.

With the method for indicating differential signal lines in a layout, the layout operator can just adjust the differential signal lines specially indicated, thus, avoiding neglect and eliminating the trouble in searching the differential signal lines.

The characteristics and practices related to the present invention will be described in detail in the preferred embodiments in accompany with drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only for, and which thus is not limitative of the present invention, and wherein:

FIG. 1A shows a flow chart of indicating the differential signal lines according to a first embodiment of the present invention; and

FIG. 1B shows a flow chart of indicating the differential signal lines according to a second embodiment of the present invention.

### DETAILED DESCRIPTION OF THE INVENTION

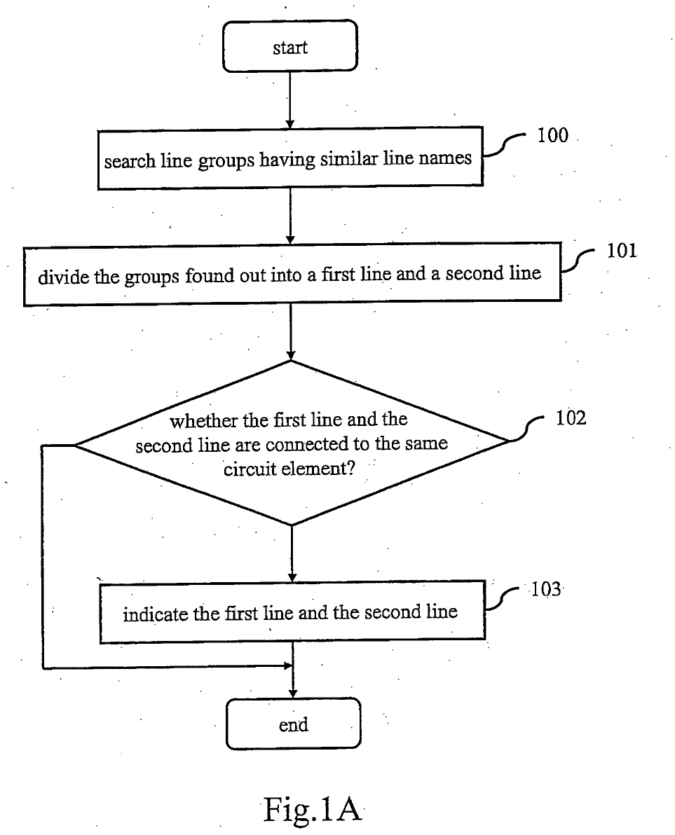

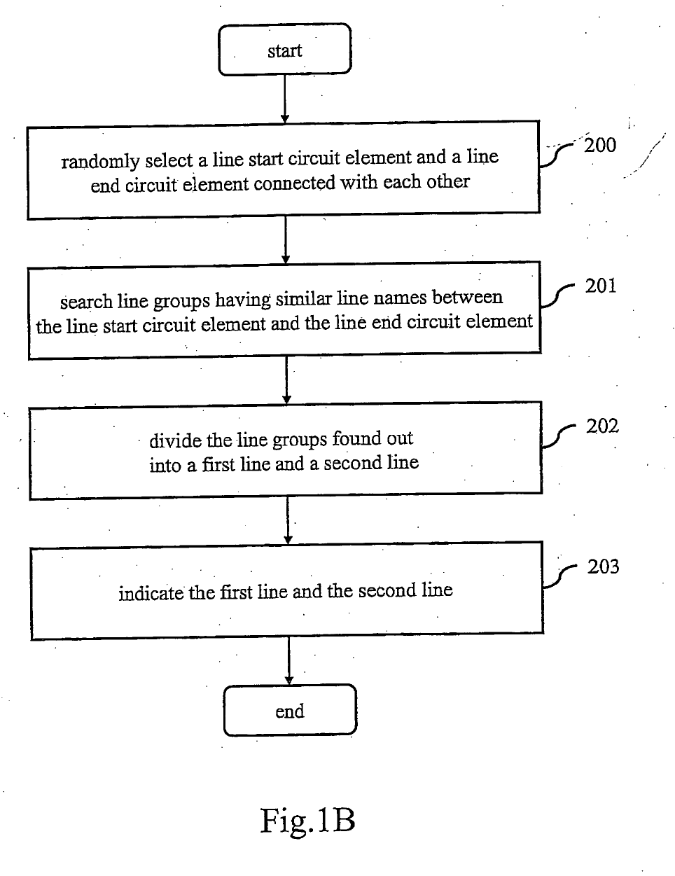

Referring to FIG. 1A, it shows a flow chart of indicating the differential signal lines according to a first embodiment of the present invention. The primary state of the layout is that each circuit element in the line diagram is placed in advance, and the connection points of each circuit element are directly connected without adjusting the wiring. The method for indicating differential signal lines comprises searching all lines in the line diagram in order to find out line groups having similar line names (step 100) at first under the condition that the first two letters of the names of the lines are same, wherein the condition can be the first three letters of the names of the lines are the same, or the first four letters of the names of the lines are the same, depending on the requirements of the layout operators.

The line groups found are compared with each other and then divided into a first line and a second line (step 101), wherein the principle of dividing the line groups is whether or not the line names are different in one letter. For example, the difference between 1394TPBN1 and 1394TPBP1 is “N” and “P”, and the difference between Line_IN_L and Line_IN_R is “L” and “R”. Moreover, the difference between the line names can be symbols, for example, the difference between USB_{—}33+ and USB_{—}33− are “+” and “−”.

Next, determine whether the first lines and the second lines are connected to the same circuit element (step 102). Generally, the differential signal lines are all connected to the same circuit element. Therefore, with this principle, whether the first line and the second line are included in a same group can be determined. When the first line and the second line are not connected to the same circuit element, the operation terminates, and the first line and the second line are not specially indicated.

When the first line and the second line are connected to the same circuit element, they are determined to be included in the same group. Then, the first line and second line are highlighted (step 103), wherein the highlighting includes changing the indication color, glittering the wiring, or thickening the wiring. The first line and the second line in each group can be indicated with a special effect, to distinguish each group of differential signal lines, for the layout operator to make a quick selection.

Referring to FIG. 1B, it shows a flow chart of indicating the differential signal lines according to a second embodiment of the present invention. The primary state of the layout is that each circuit element in the line diagram is placed in advance, and the connection points of each circuit element are directly connected without adjusting the wiring. The method for indicating differential signal lines comprises selecting a line start circuit element and a line end circuit element randomly connected with each other (step 200), to adjust the wiring, wherein the line start circuit element and the line end circuit element connected with each other are any two circuit elements connected with each other, or any multiple circuit elements connected with each other.

The line groups having similar line names between the line start element and the line end element are found out (step 201) under the condition that the first two letters of the names of the lines are same, wherein the condition can be the first three letters of the names of the lines are the same, or the first four letters of the names of the lines are the same, depending on the requirements of the layout operators.

The line groups found out are compared with each other and then divided into a first line and a second line (step 202), wherein the principle of dividing the line groups is whether the line names are different in one letter or not. For example, the difference between 1394TPBN1 and 1394TPBP1 is “N” and “P”, and the difference between Line_IN_L and Line_IN_R is “L” and “R”. Moreover, the difference between the line names can be symbols, for example, the difference between USB_{—}33+ and USB_{—}33− are “+” and “−”.

Next, the first lines and second lines are highlighted (step 203), wherein the highlighting includes changing the indication color, glittering the wiring, or thickening the wiring. The first line and the second line of each group can be indicated with a special effect, to distinguish each group of differential signal lines, for the layout operator to make a quick selection.

With the method for indicating differential signal lines in a layout, the layout operator can just adjust the differential signal lines specially indicated, thus, avoiding neglect and eliminating the trouble in searching the differential signal lines.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for indicating differential signal lines in a layout, suitable for indicating differential signal lines in a line diagram of a preplaced circuit element, comprising:
searching line groups having similar line names;
dividing the line groups into a first line and a second line;
confirming the first line and the second line are connected to a same circuit element; and
highlighting the first line and the second line.

2. The method for indicating differential signal lines in a layout as claimed in claim 1, wherein the similar line names refer to names different in one letter only.

3. The method for indicating differential signal lines in a layout as claimed in claim 1, wherein the similar line names refer to names different in one symbol only

4. The method for indicating differential signal lines in a layout as claimed in claim 1, wherein the highlighting is one selected from any combination of changing indication color, glittering the wiring, and thickening the wiring.

5. The method for indicating differential signal lines in a layout as claimed in claim 4, wherein the first line and the second line employ the same indication effect.

6. A method for indicating differential signal lines in a layout, suitable for indicating the differential signal lines in a line diagram of a preplaced circuit element, comprising:
selecting a line start element and a line end element connected with each other;
searching line groups having similar line names between the line start element and the line end element;
dividing the line groups into a first line and a second line; and
highlighting the first line and the second line.

7. The method for indicating differential signal lines in a layout as claimed in claim 6, wherein “similar line names” refers to names different in one letter only.

8. The method for indicating differential signal lines in a layout as claimed in claim 6, “similar line names” refers to names different in one symbol only.

9. The method for indicating differential signal lines in a layout as claimed in claim 6, wherein the highlighting is one selected from any combination of changing indication color, glittering the wiring, and thickening the wiring.

10. The method for indicating differential signal lines in a layout as claimed in claim 9, wherein the first line and the second line employ the same indication effect.
